(19) United States
(12) Patent Application Publication
(10) Pub. No.: US 2023/0068773 A1
(43) Pub. Date: Mar. 2, 2023

(54) VIBRATION GENERATING DEVICE AND PICKUP SYSTEM

(71) Applicant: SEIKO EPSON CORPORATION, Tokyo (JP)

(72) Inventors: Takayuki TAKEUCHI, MATSUMOTO-SHI (JP); Takanori SUZUKI, CHINO-SHI (JP)

(21) Appl. No.: 17/895,096

(22) Filed: Aug. 25, 2022

(30) Foreign Application Priority Data
Aug. 27, 2021 (JP) 2021-138679

(51) Int. Cl. B65G 47/90; H02K 7/06

(52) U.S. Cl. CPC B65G 47/90; H02K 7/063

(57) ABSTRACT

A vibration generating device includes: a trough where a workpiece is placed; a leg part supporting the trough; and a vibration motor applying a vibration to the trough. The leg part has a spring part that is elastically deformed, and a first fixing part located between the spring part and the trough and fixing the spring part to the trough. The spring part and the first fixing part are unified. The leg part is a machine-cut component.

The present application is based on, and claims priority from JP Application Serial Number 2021-138679, filed Aug. 27, 2021, the disclosure of which is hereby incorporated by reference herein in its entirety.

### BACKGROUND

### 1. Technical Field

The present disclosure relates to a vibration generating device and a pickup system.

### 2. Related Art

Japanese Utility Model Registration No. 3,175,501 describes a vibratory conveyor device which has a base, a frame supported to the base via a plurality of spring legs, and a conveyor trough arranged in the frame and in which the conveyor trough is vibrated by a vibration motor so as to convey a powder or granular material.

However, in the vibratory conveyor device of Japanese Utility Model Registration No. 3,175,501, the configuration of the spring leg is not clear. For example, if a spring main body, a top fixing part fixing a top end part of the spring main body to the frame, and a bottom fixing part fixing a bottom end part of the spring main body to the base, are formed by separate components, the spring leg vibrates due to the driving of the vibration motor and therefore a stress is applied to a junction part between the spring main body and the top fixing part or a junction part between the spring main body and the bottom fixing part, posing a risk of breaking this junction part.

### SUMMARY

A vibration generating device according to an aspect of the present disclosure includes: a trough where a workpiece is placed; a leg part supporting the trough; and a vibration motor applying a vibration to the trough. The leg part has a spring part that is elastically deformed, and a first fixing part located between the spring part and the trough and fixing the spring part to the trough. The spring part and the first fixing part are unified.

A pickup system according to another aspect of the present disclosure includes: a vibration generating device where a workpiece is placed and that applies a vibration to the workpiece and thus changes a position of the workpiece; a vision unit picking up an image of the workpiece placed in the vibration generating device and detecting the position of the workpiece, based on a result of image pickup; and a robot picking up the workpiece placed in the vibration generating device, based on a result of detection by the vision unit. The vibration generating device includes: a trough where the workpiece is placed; a leg part supporting the trough; and a vibration motor applying a vibration to the trough. The leg part has a spring part that is elastically deformed, and a first fixing part located between the spring part and the trough and fixing the spring part to the trough. The spring part and the first fixing part are unified.

### BRIEF DESCRIPTION OF THE DRAWINGS

FIG. 1 is a front view showing an overall configuration of a pickup system according to a first embodiment.

FIG. 2 is a front view showing a robot.

FIG. 3 is a front view showing a vibration generating device.

FIG. 4 is a top view showing the vibration generating device.

FIG. 5 is a cross-sectional view showing a leg part provided in the vibration generating device.

FIG. 6 is a flowchart showing a method for driving the pickup system.

FIG. 7 is a cross-sectional view showing a modification example of the leg part shown in FIG. 5.

FIG. 8 is a cross-sectional view showing a modification example of the leg part shown in FIG. 5.

FIG. 9 is a cross-sectional view showing a modification example of the leg part shown in FIG. 5.

FIG. 10 is a cross-sectional view showing a modification example of the leg part shown in FIG. 5.

FIG. 11 is a cross-sectional view showing a modification example of the leg part shown in FIG. 5.

FIG. 12 is a cross-sectional view showing a leg part provided in a vibration generating device according to a second embodiment.

FIG. 13 is a cross-sectional view showing a modification example of the leg part shown in FIG. 12.

### DESCRIPTION OF EXEMPLARY EMBODIMENTS

Preferred embodiments of a vibration generating device and a pickup system will now be described with reference to the accompanying drawings.

### First Embodiment

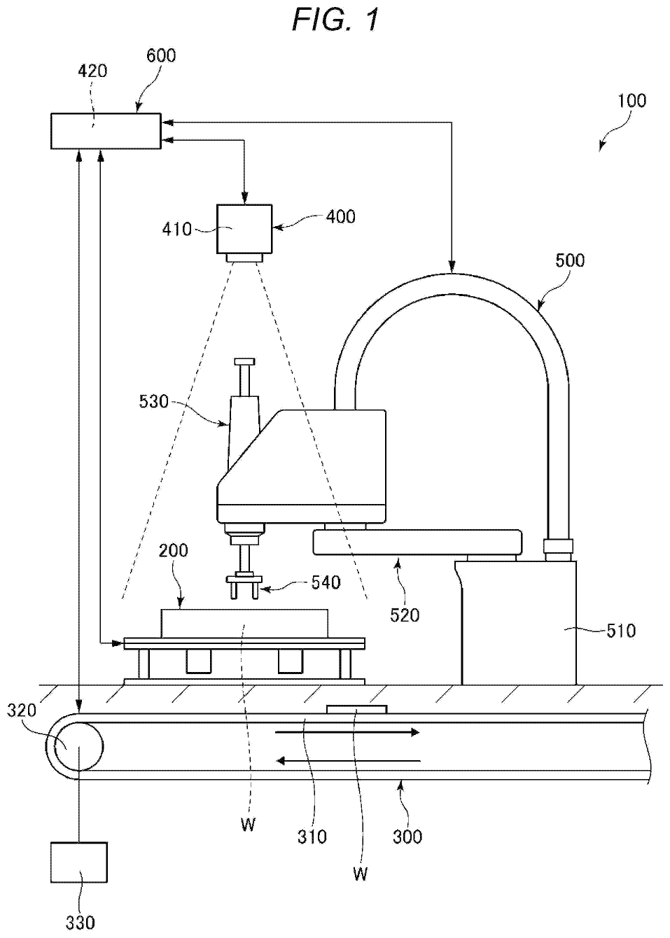

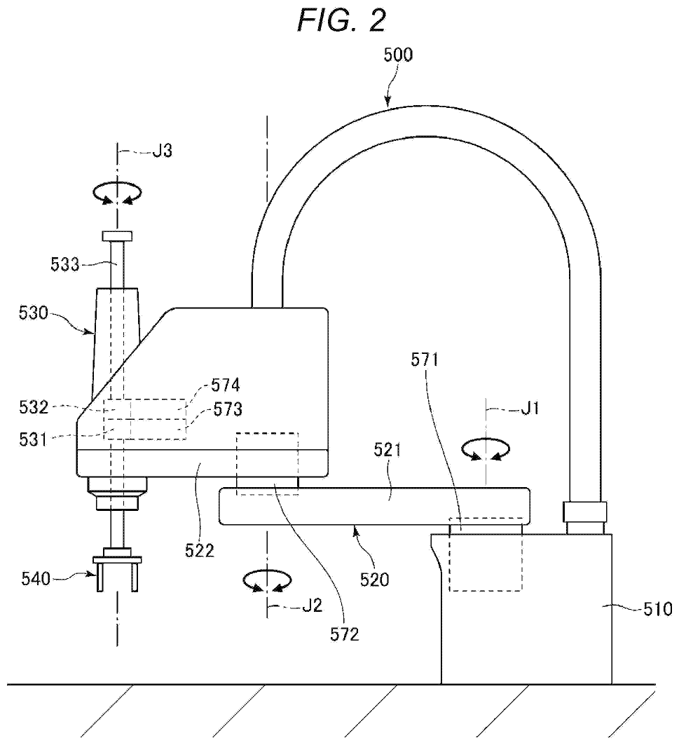

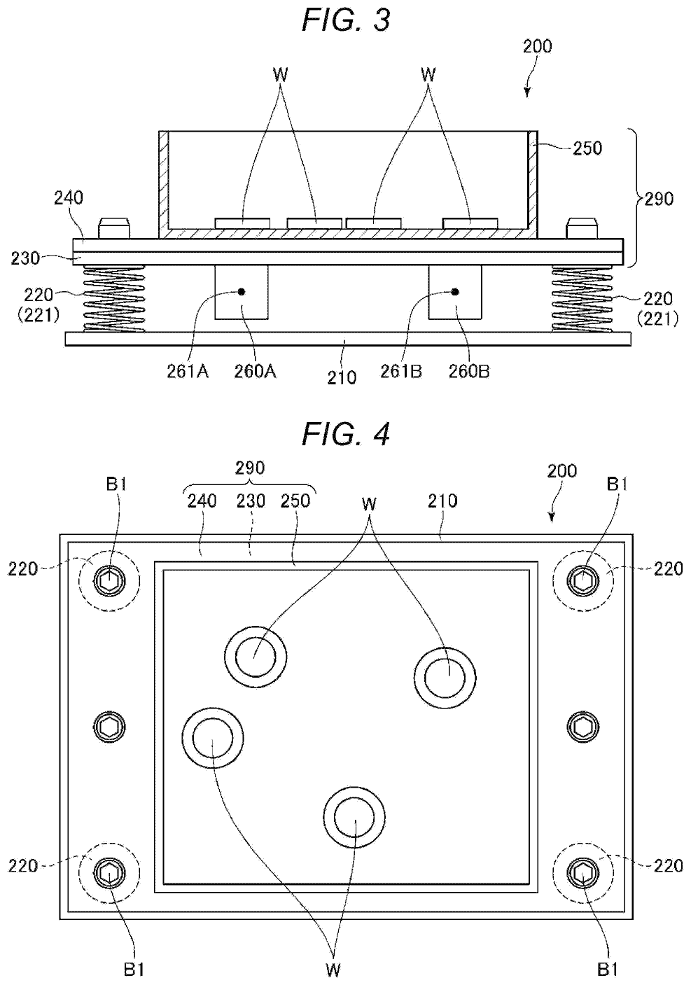

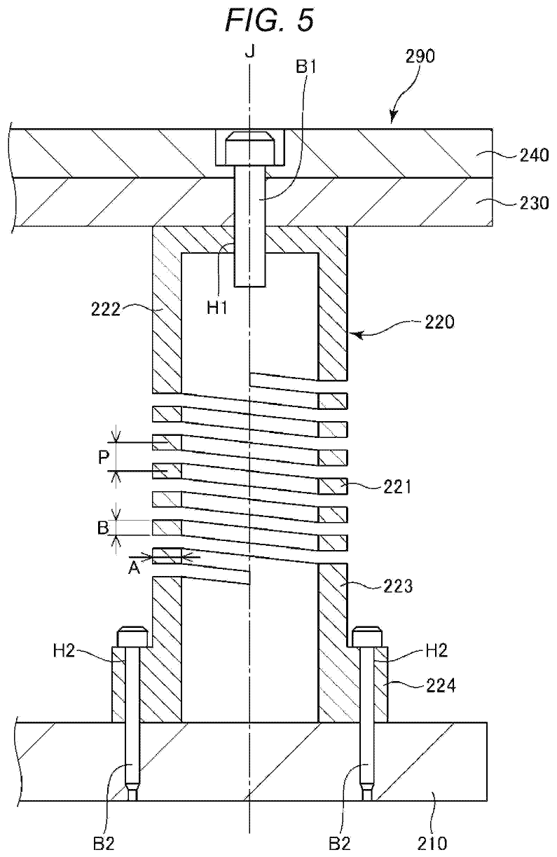

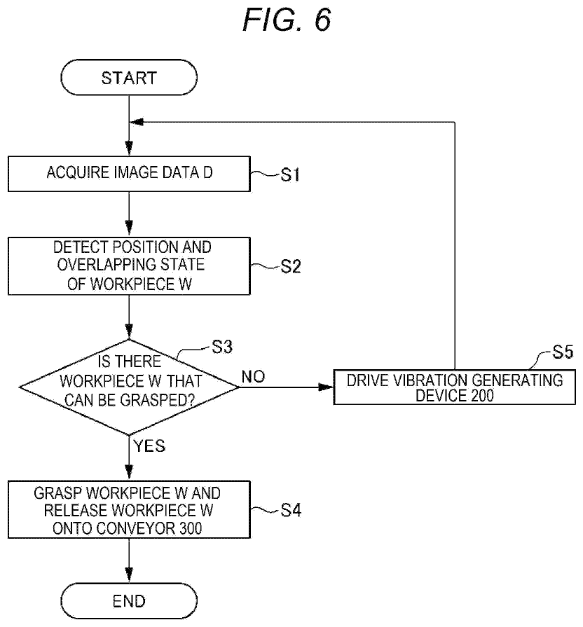

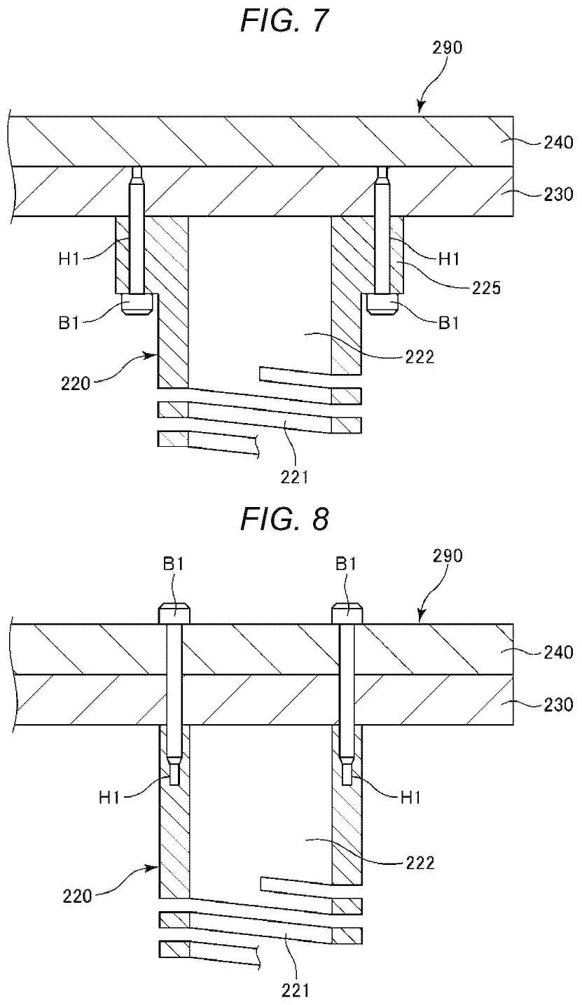

FIG. 1 is a front view showing an overall configuration of a pickup system according to a first embodiment. FIG. 2 is a front view showing a robot. FIG. 3 is a front view showing a vibration generating device. FIG. 4 is a top view showing the vibration generating device. FIG. 5 is a cross-sectional view showing a leg part provided in the vibration generating device. FIG. 6 is a flowchart showing a method for driving the pickup system. FIGS. 7 to 11 are cross-sectional views each showing a modification example of the leg part shown in FIG. 5. In the description below, the top side in the drawings except FIGS. 4 and 6 is defined as “top” and the bottom side in the drawings is defined as “bottom”.

A pickup system 100 shown in FIG. 1 has: a vibration generating device 200 where a workpiece W, which is an object to be conveyed, is placed; a conveyor 300 as a conveyance device conveying the workpiece W; a vision unit 400 picking up an image of the workpiece W placed in the vibration generating device 200; a robot 500 picking up the workpiece W placed in the vibration generating device 200, based on the result of detection by the vision unit 400, and releasing the workpiece W onto the conveyor 300; and a control device 600 controlling the driving of each of these parts.

### Robot 500

The robot 500 is a SCARA robot (horizontal articulated robot). As shown in FIG. 2, the robot 500 has a base 510 fixed to a floor surface and a robot arm 520 coupled to the base 510. The robot arm 520 has a first arm 521 whose proximal end part is coupled to the base 510 and which rotationally moves about a first axis of rotational motion J1 laid along the vertical direction in relation to the base 510, and a second arm 522 whose proximal end part is coupled to a distal end part of the first arm 521 and which rotationally moves about a second axis of rotational motion J2 laid along the vertical direction in relation to the first arm 521.

A work head 530 is provided at a distal end part of the second arm 522. The work head 530 has a spline nut 531 and a ball screw nut 532 coaxially arranged at the distal end part of the second arm 522, and a spline shaft 533 inserted in the spline nut 531 and the ball screw nut 532. The spline shaft 533 is rotatable about a third axis of rotational motion J3 laid along the vertical direction in relation to the second arm 522 and is movable up and down along the third axis of rotational motion J3.

An end effector 540 is attached to a bottom end part of the spline shaft 533. As the end effector 540, a removable end effector suitable for the target work is selected. The end effector 540 in this embodiment is a hand gripping and holding the workpiece W.

The robot 500 also has a first drive device 571 causing the first arm 521 to rotationally move about the first axis of rotational motion J1 in relation to the base 510, a second drive device 572 causing the second arm 522 to rotationally move about the second axis of rotational motion J2 in relation to the first arm 521, a third drive device 573 causing the spline nut 531 to rotate and thus causing the spline shaft 533 to rotate about the third axis of rotational motion J3, and a fourth drive device 574 causing the ball screw nut 532 to rotate and thus causing the spline shaft 533 to move up or down in a direction along the third axis of rotational motion J3.

In each of the first, second, third, and fourth drive devices 571, 572, 573, 574, a motor as a drive source and an encoder detecting the amount of rotation of the motor are installed. The control device 600 executes feedback control so that the position of the robot arm 520 indicated by an output from each encoder coincides with a target position, which is a control target, during the operation of the pickup system 100.

The robot 500 has been described. However, the robot 500 is not particularly limited and may be, for example, a 6-axis robot having a robot arm with six axes of rotation.

### Conveyor 300

As shown in FIG. 1, the conveyor 300 has a belt 310 where the workpiece W is placed, a conveyance roller 320 moving the belt 310, a motor, not illustrated, for driving the conveyance roller 320, and an amount-of-conveyance sensor 330 outputting a signal corresponding to the amount of rotation of the conveyance roller 320 to the control device 600. The control device 600 executes feedback control so that the speed of conveyance of the workpiece W indicated by the output from the amount-of-conveyance sensor 330 coincides with a target speed of conveyance, which is a control target, during the operation of the pickup system 100. Thus, the workpiece W can be conveyed stably at a desired speed.

### Vision Unit 400

As shown in FIG. 1, the vision unit 400 is a device picking up an image of the workpiece W at the top of the vibration generating device 200 from above the vibration generating device 200 and detecting the position and the overlapping state of the workpiece W, based on the picked-up image. Such a vision unit 400 has a camera 410, and a detection unit 420 detecting the position of at least one workpiece W at the top of the vibration generating device 200, based on image data picked up by the camera 410. In this embodiment, the detection unit 420 is embedded in the control device 600.

The camera 410 is a 3D camera (stereo camera) that can pick up a distance image having depth information (spatial depth information) at each pixel. Each pixel in the camera 410 is associated with global coordinates by the detection unit 420. When the workpiece W exists within the angle of view of the camera 410, the coordinates of the workpiece W can be specified, based on the position of the workpiece W in the image data. However, the configuration of the vision unit 400 is not particularly limited. The vision unit 400 may be configured, for example, by a combination of a 2D camera and a depth sensor or by using a measuring device measuring a three-dimensional shape by the phase shift method.

### Vibration Generating Device 200

The vibration generating device 200 has a plate-like base 210, four leg parts 220 standing up at the base 210, a trough 290 coupled to the base 210 via the leg parts 220, and a first vibration motor 260A and a second vibration motor 260B applying a vibration to the trough 290, as shown in FIG. 3. The trough 290 has a plate-like transmission unit 230 coupled to the base 210 via the leg parts 220 and having the first and second vibration motors 260A, 260B arranged at a bottom surface thereof, a plate-like trough support unit 240 superimposed on a top surface of the transmission unit 230, and a trough main body 250 that is arranged at a top surface of the trough support unit 240 and where the workpiece W is placed. The configuration of the trough 290 is not particularly limited. For example, the transmission unit 230 and the trough support unit 240 may be omitted.

In the vibration generating device 200 with such a configuration, as the driving of the first and second vibration motors 260A, 2606 is controlled by the control device 600, a vibration is applied to the trough 290 and the position and the overlapping state of the workpiece W placed in the trough main body 250 can thus be changed. Also, the direction of the vibration applied to the trough 290 can be changed by changing the phase (angle difference of the direction of eccentricity) and the direction of rotation of the first and second vibration motors 260A, 260B.

The plate-like transmission unit 230 is fixed substantially horizontally to the base 210 via the four leg parts 220. Therefore, the transmission unit 230 can easily shake in relation to the base 210 and the vibration of the first and second vibration motors 260A, 2606 is augmented and transmitted to the trough 290. The trough support unit 240 is in the shape of a plate and superimposed on the top surface of the transmission unit 230. The trough support unit 240 is screwed to the transmission unit 230 with a plurality of screws. The trough main body 250 is in the shape of a box and arranged substantially horizontally at the top surface of the trough support unit 240. A plurality of workpieces W are randomly accommodated in the trough main body 250.

The first vibration motor 260A and the second vibration motor 260B are arranged at the bottom surface of the transmission unit 230. A rotary shaft 261A of the first vibration motor 260A and a rotary shaft 261B of the second vibration motor 260B are each laid along the horizontal direction and are parallel to each other. The rotary shaft 261A and the rotary shaft 261B are located on the same horizontal plane. The first and second vibration motors 260A, 260B are not particularly limited, provided that the first and second vibration motors 260A, 260B can generate a vibration. For example, an electromagnetic motor in which an eccentric weight, not illustrated, is arranged at the rotary shaft 261A, 261B and in which the action of the eccentric weight generates a centrifugal vibration in the rotary shaft 262A, 261B, can be used.

As shown in FIG. 4, the four leg parts 220 are arranged in a well-balanced manner in the four corners of the base 210. The four leg parts 220 will now be described. These leg parts have similar configurations. Therefore, in the description below, one leg part 220 is described and the description of the other leg parts 220 is omitted.

As shown in FIG. 5, the leg part 220 has a spring part 221 that is elastically deformed, a first fixing part 222 located between the spring part 221 and the trough 290 and fixing the spring part 221 to the trough 290, and a second fixing part 223 located between the spring part 221 and the base 210 and fixing the spring part 221 to the base 210. The spring part 221 is a coil spring. The spring part 221, the first fixing part 222, and the second fixing part 223 are formed as a unified body. As the entirety of the leg part 220 is thus formed as unified body, the mechanical strength of the leg part 220 is higher and therefore the breakage of the leg part 220 is more effectively restrained, than in a configuration where these parts are formed as separate parts. Therefore, the vibration generating device 200 has high reliability.

Also, when the spring part 221, the first fixing part 222, and the second fixing part 223 are separate parts, the characteristics (spring coefficient and the like) of the spring part 221 changes due to the coupling of the first and second fixing parts 222, 223 to the spring part 221 and therefore it is difficult to equalize the characteristics of the spring parts 221 in the four leg parts 220. Specifically, when an adhesive is used for the fixing, the adhesive adheres to the spring part 221 and thus changes the characteristics of the spring part 221. When welding is used for the fixing, the heat at the time of welding changes the characteristics of the spring part 221. Therefore, it is difficult to stably vibrate the trough 290 in a predetermined direction. In contrast, when the spring part 221, the first fixing part 222, and the second fixing part 223 are formed as a unified body as in this embodiment, the change in the characteristics of the spring part 221 as described above does not occur and therefore the characteristics of the spring parts 221 in the four leg parts 220 can be easily equalized. Thus, the trough 290 can be stably vibrated in a predetermined direction.

Particularly in this embodiment, the spring part 221, the first fixing part 222, and the second fixing part 223 are formed as a unified body, for example, by machine-cutting a columnar block unit. That is, the leg part 220 is formed as a machine-cut component. Thus, the leg part 220 can be formed easily at a low cost and with high machining accuracy. Therefore, the trough 290 can be stably vibrated in a predetermined direction.

Also, the machine-cutting enables easy setting and adjustment of a lateral width A, a longitudinal width B, and a pitch P of the spring part 221 to any value. Therefore, the amplitude in the longitudinal direction and the amplitude in the lateral direction of the trough 290 can be separately adjusted into any range. Thus, the vibration generating device 200 has an excellent vibration characteristic.

However, the method for forming the leg part 220 is not particularly limited. For example, electrical discharge machining, injection molding, casting and molding, forging and molding, molding by 3D printer, or the like, may be employed. Such forming methods, too, enable relatively free designing of the shape of the spring part 221.

The first fixing part 222 located at the top side in the vertical direction of the spring part 221 has a closed cylindrical shape closed at the top end. At the top end, a hole H1 along the vertical direction is formed. Particularly in this embodiment, the hole H1 extends along a center axis J of the leg part 220. The hole H1 is threaded and a bolt B1 penetrating the trough support unit 240 and transmission unit 230 is fastened therein. Thus, the first fixing part 222 and the trough 290 can be easily fixed together.

However, the method for fixing the first fixing part 222 and the trough 290 together is not particularly limited. For example, bonding, welding or the like may be employed. Particularly when welding is used, it is preferable to lengthen the first fixing part 222 in the axial direction so that the heat at the time of welding is less likely to be transferred to the spring part 221 via the first fixing part 222.

The hole H1 is located inside the spring part 221, as viewed in a plan view from the vertical direction, which is the direction in which the spring part 221 and the first fixing part 222 are arrayed. Therefore, the first fixing part 222 can be miniaturized. Also, since the first fixing part 222 and the trough 290 can be fixed together with one bolt B1, the components of the vibration generating device 200 can be reduced and the vibration generating device 200 can be assembled easily.

Meanwhile, the second fixing part 223 located at the bottom side in the vertical direction of the spring part 221 has a cylindrical shape open at the bottom end. The second fixing part 223 has an annular flange part 224 protruding outward from the spring part 221 as viewed in a plan view from the vertical direction. A pair of holes H2 laid along the vertical direction are formed in the flange part 224. Bolts B2 inserted in these holes H2 are fastened in screw holes formed in the base 210. Thus, the spring part 221 is fixed to the base 210 via the second fixing part 223.

However, the method for fixing the second fixing part 223 and the base 210 together is not particularly limited. For example, bonding, welding or the like may be employed. Particularly when welding is used, it is preferable to lengthen the second fixing part 223 in the axial direction so that the heat at the time of welding is less likely to be transferred to the spring part 221 via the second fixing part 223.

The holes H2 are located outside of the spring part 221 as viewed in a plan view from the vertical direction. Therefore, the second fixing part 223 is greater in size than the first fixing part 222 having the hole H1 located inside the spring part 221 as viewed in a plan view from the vertical direction as described above. However, the strength of the second fixing part 223 and the joining strength between the second fixing part 223 and the base 210 can be increased accordingly.

If the second fixing part 223 has a configuration similar to the first fixing part 222, further miniaturization of the leg part 220, reduction of components, and simplification of the assembling can be achieved. However, in this case, the leg part 220 has a hollow structure closed at both the top and bottom ends and, in practice, cannot be formed by machine-cutting. To cope with this, in this embodiment, the first fixing part 222 at the top end side has a closed cylindrical shape and the second fixing part 223 at the bottom end side has a cylindrical shape, that is, the shapes of the first and second fixing parts 222, 223 are optimized. Thus, the leg part 220 has a shape that can be formed by machine-cutting, and can achieve a high strength with a small size.

The material forming the leg part 220 as described above is not particularly limited. Various metal materials (including alloys) such as stainless steel and aluminum-based alloy and various resin materials may be used. In this embodiment, stainless steel is used. Thus, the leg part 220 has excellent corrosion resistance and mechanical strength.

### Control Device 600

The control device 600 controls the driving of each of the vibration generating device 200, the conveyor 300, the vision unit 400, and the robot 500. Such a control device 600 has, for example, a processor (CPU) formed by a computer and processing information, a memory communicatively coupled to the processor, and an external interface for coupling to an external device. In the memory, various programs executable by the processor are saved. The processor can read and execute the various programs and the like stored in the memory. A part or all of the components of the control device 600 may be arranged inside the casing of the robot 500. The control device 600 may also be formed by a plurality of processors.

The pickup system 100 has been described. A method for driving the pickup system 100 will now be briefly described with reference to FIG. 6. First, in step S1, in the state where the robot 500 is in an attitude that does not obstruct image pickup, an image of the workpiece W in the trough main body 250 is picked up by the camera 410 and image data D is thus acquired. Next, in step S2, the position and the overlapping state of at least one workpiece W are detected, based on the image data D. For example, template matching can be used to detect the position and the overlapping state of the workpiece W.

Next, in step S3, whether or not there is a workpiece W that can be grasped by the robot 500 among the workpieces W whose positions are detected, is detected. As a condition for determining that a workpiece W can be grasped, for example, the position of the workpiece W in the trough main body 250 or the overlapping state with another workpiece W or the like can be set. When there is a workpiece W that can be grasped by the robot 500, the workpiece W is grasped by the robot 500 and released onto the belt 310 of the conveyor 300 in step S4. Thus, the workpiece W is conveyed to a predetermined place by the conveyor 300.

Meanwhile, when there is no workpiece W that can be grasped by the robot 500 in step S3, the vibration generating device 200 is driven in step S5 to reset the position of the workpiece W in the trough main body 250 or resolve the overlap of workpieces W, and execute the processing again from step S1. Such a driving method enables the robot 500 to grasp the workpiece W more securely.

The pickup system 100 has been described. The vibration generating device 200 included in such a pickup system 100 has: the trough 290, where the workpiece W is placed; the leg part 220 supporting the trough 290; and the first and second vibration motors 260A, 260B as vibration motors applying a vibration to the trough 290. The leg part 220 has the spring part 221, which is elastically deformed, and the first fixing part 222 located between the spring part 221 and the trough 290 and fixing the spring part 221 to the trough 290. The spring part 221 and the first fixing part 222 are unified. Thus, the mechanical strength of the leg part 220 is higher and therefore the breakage of the leg part 220 is more effectively restrained, than in a configuration where these parts are formed as separate parts. Therefore, the vibration generating device 200 has high reliability.

As described above, the leg part 220 is a machine-cut component. Thus, the leg part 220 can be formed easily at a low cost and with high machining accuracy. Therefore, the trough 290 can be stably vibrated in a predetermined direction. Also, the spring part 221 can be easily set and adjusted in any shape. Therefore, the amplitude in the longitudinal direction and the amplitude in the lateral direction of the trough 290 can be separately adjusted into any range. Thus, the vibration generating device 200 has an excellent vibration characteristic.

As described above, the first fixing part 222 has the hole H1 for fixing to the trough 290. Thus, the first fixing part 222 can be easily fixed to the trough 290.

As described above, the hole H1 is located inside the spring part 221, as viewed in a plan view from the vertical direction, which is the direction in which the spring part 221 and the first fixing part 222 are arrayed. Therefore, the first fixing part 222 can be miniaturized.

As described above, the leg part 220 also has the second fixing part 223 located on the other side of the spring part 221 from the first fixing part 222 and fixing the spring part 221. The spring part 221 and the second fixing part 223 are unified. Thus, the spring part 221 can be more easily fixed to the base 210 via the second fixing part 223. Also, the mechanical strength of the leg part 220 is higher and therefore the breakage of the leg part 220 is more effectively restrained, than in a configuration where these parts are formed as separate parts. Therefore, the vibration generating device 200 has high reliability.

As described above, the pickup system 100 has: the vibration generating device 200, where the workpiece W is placed and which applies a vibration to the workpiece Wand thus changes the position of the workpiece W; the vision unit 400 picking up an image of the workpiece W placed in the vibration generating device 200 and detecting the position of the workpiece W, based on the result of the image pickup; and the robot 500 picking up the workpiece W placed in the vibration generating device 200, based on the result of the detection by the vision unit 400. The vibration generating device 200 has: the trough 290, where the workpiece W is placed; the leg part 220 supporting the trough 290; and the first and second vibration motors 260A, 260B as vibration motors applying a vibration to the trough 290. The leg part 220 has the spring part 221, which is elastically deformed, and the first fixing part 222 located between the spring part 221 and the trough 290 and fixing the spring part 221 to the trough 290. The spring part 221 and the first fixing part 222 are unified. Thus, the mechanical strength of the leg part 220 is higher and therefore the breakage of the leg part 220 is more effectively restrained, than in a configuration where these parts are formed as separate parts. Therefore, the pickup system 100 has high reliability.

The pickup system 100 according to the first embodiment has been described above. However, the configuration of the pickup system 100, particularly the configuration of the leg part 220, is not limited to the configuration described in the embodiment. Several modification examples of the first fixing part 222 will now be described. Such modification examples can also be applied to the second fixing part 223.

For example, in a modification example shown in FIG. 7, the first fixing part 222 has a configuration similar to the second fixing part 223 in the embodiment. That is, the first fixing part 222 has a cylindrical shape open at the top end and has an annular flange part 225 protruding outward. In this flange part 225, a pair of holes H1 laid along the vertical direction are formed. The pair of holes H1 are located outside of the spring part 221 as viewed in a plan view from the vertical direction. Bolts B1 inserted in these holes H1 are fastened in screw holes formed in the transmission unit 230. Thus, the spring part 221 is fixed to the transmission unit 230 via the first fixing part 222.

In this way, the holes H1 may be located outside of the spring part 221 as viewed in a plan view from the direction in which the spring part 221 and the first fixing part 222 are arrayed, that is, from the vertical direction. Thus, the strength of the first fixing part 222 and the joining strength between the first fixing part 222 and the trough 290 can be increased.

In a modification example shown in FIG. 8, the first fixing part 222 has a cylindrical shape open at the top end and has a pair of holes H1 located between the inner circumference and the outer circumference of the spring part 221 as viewed in a plan view from the vertical direction. These holes H1 are threaded and bolts B1 inserted in the trough support unit 240 and transmission unit 230 are fastened therein. Thus, the spring part 221 is fixed to the transmission unit 230 via the first fixing part 222. Such a configuration can achieve the miniaturization of the first fixing part 222.

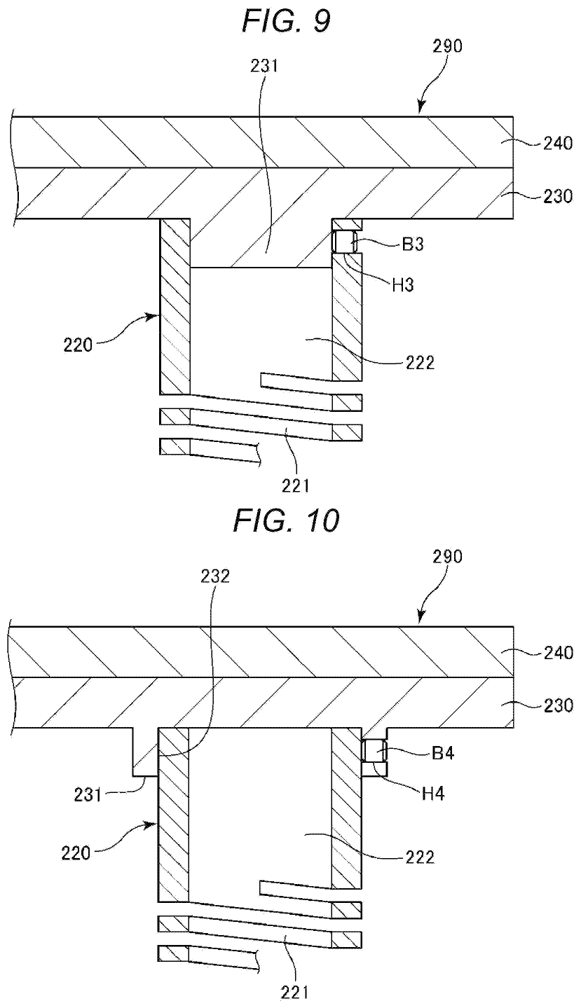

Also, as shown in FIG. 9, the transmission unit 230 has a protrusion 231 protruding downward. Meanwhile, the first fixing part 222 has a cylindrical shape open at the top end to enable the insertion of the protrusion 231 and also has a hole H3 penetrating the outer circumferential surface and the inner circumferential surface and extending in the horizontal direction. The hole H3 is threaded. The leg part 220 is arranged in such a way that the protrusion 231 is inserted in the first fixing part 222. A bolt B3 is spirally engaged with the hole H3. The bolt B3 is fastened and pressed against the side surface of the protrusion 231. The first fixing part 222 and the transmission unit 230 may thus be fixed together. Such a configuration enables the hole H3 to be approached in the horizontal direction from the space between the base 210 and the trough 290. Therefore, the fastening of the bolt B3 is easy. Particularly in this embodiment, a hollow set screw is used as the bolt B3. Thus, the protrusion of the bolt B3 to the outer circumference of the first fixing part 222 is restrained and the first fixing part 222 can be miniaturized accordingly.

In this way, the hole H3 may extend in the direction orthogonal to the direction in which the spring part 221 and the first fixing part 222 are arrayed, that is, to the vertical direction. Thus, the hole H3 can be approached easily and the fastening of the bolt B3 is easy.

Also, as shown in FIG. 10, the transmission unit 230 has the protrusion 231 protruding downward, an insertion hole 232 open at the bottom side of the protrusion 231 and having the first fixing part 222 inserted therein, and a hole H4 penetrating the outer circumferential surface and the inner circumferential surface of the protrusion 231 and extending in the horizontal direction. The hole H4 is threaded. The first fixing part 222 is inserted in the insertion hole 232. A bolt B4 is spirally engaged with the hole H4. The bolt B4 is fastened and pressed against the side surface of the first fixing part 222. The first fixing part 222 and the transmission unit 230 may thus be fixed together.

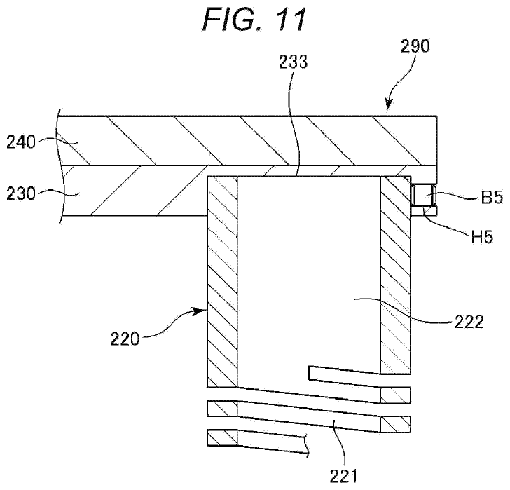

Also, as shown in FIG. 11, the transmission unit 230 has an insertion hole 233 open at the bottom side and having the first fixing part 222 inserted therein, and a hole H5 penetrating the side surface of the transmission unit 230 and the inner circumferential surface of the insertion hole 233 and extending in the horizontal direction. The hole H5 is threaded. The first fixing part 222 is inserted in the insertion hole 233. A bolt B5 is spirally engaged with the hole H5. The bolt B5 is fastened and pressed against the side surface of the first fixing part 222. The first fixing part 222 and the transmission unit 230 may thus be fixed together.

### Second Embodiment

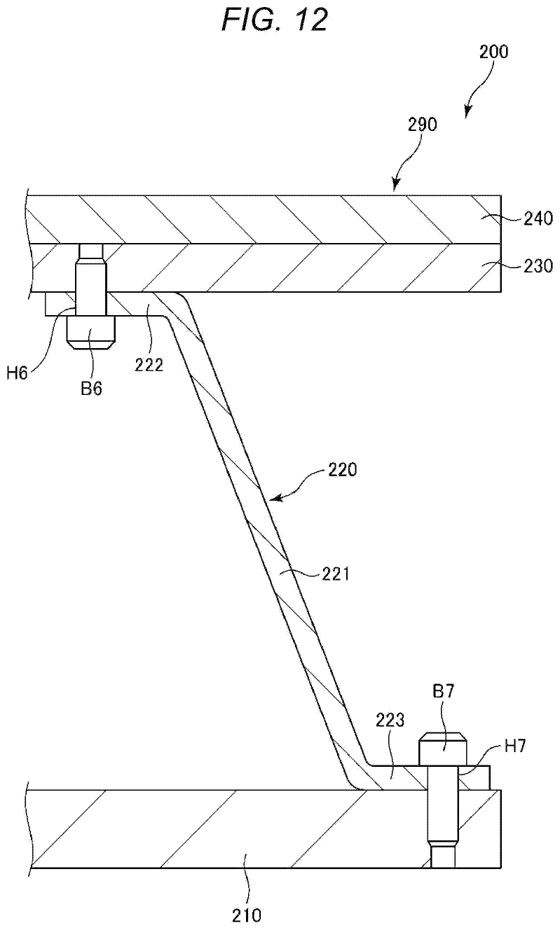

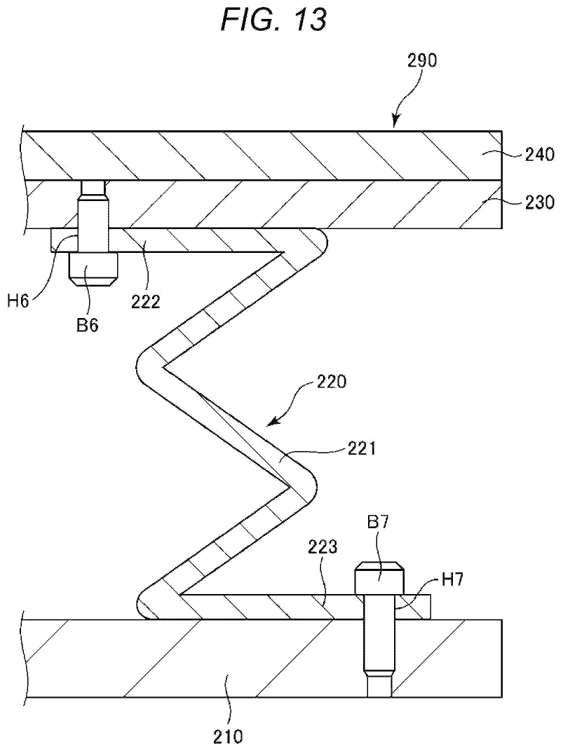

FIG. 12 is a cross-sectional view showing a leg part provided in a vibration generating device according to a second embodiment. FIG. 13 is a cross-sectional view showing a modification example of the leg part shown in FIG. 12.

The vibration generating device 200 according to this embodiment is similar to the vibration generating device 200 in the first embodiment except for the configuration of the leg part 220. Therefore, in the description below, this embodiment is described mainly in terms of the difference from the first embodiment, and similar matters are not described further. In the drawings according to this embodiment, components similar to those in the foregoing embodiment are denoted by the same reference signs. The four leg parts 220 have configurations similar to each other. Therefore, in the description below, for the sake of convenience of the description, one leg part 220 is described and the description of the other leg parts 220 is omitted.

As shown in FIG. 12, in the leg part 220 in this embodiment, the spring part 221 is formed by a leaf spring. The first and second fixing parts 222, 223 are coupled in a unified form to both ends of the leg part 220. In such a configuration, the leg part 220 can be formed simply by bending a plate member at a plurality of positions. Therefore, the leg part 220 can be formed very easily.

A hole H6 is formed in the first fixing part 222. A bolt B6 inserted in the hole H6 is fastened in a screw hole in the transmission unit 230. Thus, the first fixing part 222 is fixed to the transmission unit 230. Also, a hole H7 is formed in the second fixing part 223. A bolt B7 inserted in the hole H7 is fastened in a screw hole in the base 210. Thus, the second fixing part 223 is fixed to the base 210. However, the method for fixing the first and second fixing parts 222, 223 is not particularly limited.

As described above, in the vibration generating device 200 according to this embodiment, the spring part 221 is a leaf spring. Therefore, the leg part 220 has a simple configuration and is easily formed.

Such a second embodiment, too, can achieve effects similar to those of the first embodiment. Also, the shape of the spring part 221 is not particularly limited. For example, the spring part 221 may be bent or curved in the middle, as shown in FIG. 13.

The vibration generating device and the pickup system according to the present disclosure have been described, based on the illustrated embodiments. However, the present disclosure is not limited to these embodiments. The configuration of each part can be replaced with any configuration having a similar function. Also, any other component may be added to the present disclosure. The embodiments may be combined together where appropriate.

What is claimed is:

1. A vibration generating device comprising:
a trough where a workpiece is placed;
a leg part supporting the trough; and
a vibration motor applying a vibration to the trough, wherein
the leg part has a spring part that is elastically deformed, and a first fixing part located between the spring part and the trough and fixing the spring part to the trough, and
the spring part and the first fixing part are unified.

2. The vibration generating device according to claim 1, wherein
the leg part is a machine-cut component.

3. The vibration generating device according to claim 1, wherein
the first fixing part has a hole for fixing to the trough.

4. The vibration generating device according to claim 3, wherein
the hole is located outside of the spring part, as viewed in a plan view from a direction in which the spring part and the first fixing part are arrayed.

5. The vibration generating device according to claim 3, wherein
the hole is located inside the spring part, as viewed in a plan view from a direction in which the spring part and the first fixing part are arrayed.

6. The vibration generating device according to claim 3, wherein
the hole extends in a direction orthogonal to a direction in which the spring part and the first fixing part are arrayed.

7. The vibration generating device according to claim 1, wherein
the leg part further includes a second fixing part located on the other side of the spring part from the first fixing part and fixing the spring part, and
the spring part and the second fixing part are unified.

8. The vibration generating device according to claim 1, wherein
the sprint part is a leaf spring.

9. A pickup system comprising:
a vibration generating device where a workpiece is placed and that applies a vibration to the workpiece and thus changes a position of the workpiece;
a vision unit picking up an image of the workpiece placed in the vibration generating device and detecting the position of the workpiece, based on a result of image pickup; and
a robot picking up the workpiece placed in the vibration generating device, based on a result of detection by the vision unit,
the vibration generating device comprising:
a trough where the workpiece is placed;
a leg part supporting the trough; and
a vibration motor applying a vibration to the trough, wherein
the leg part has a spring part that is elastically deformed, and a first fixing part located between the spring part and the trough and fixing the spring part to the trough, and
the spring part and the first fixing part are unified.
